(19) United States
(12) Patent Application Publication
(10) Pub. No.: US 2007/0147260 A1
(43) Pub. Date: Jun. 28, 2007

(54) Method for loading a list of alarms by means of an alarm application

(76) Inventor: Bernd Schwarzmann, Augsburg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/639,516

(22) Filed: Dec. 15, 2006

(30) Foreign Application Priority Data
Dec. 19, 2005 (EP) 05112400.6

(51) Int. Cl. H04J 3/14; H04J 1/16

(52) U.S. Cl. 370/242; 370/216

(57) ABSTRACT

In on aspect, method for loading a list of alarms by means of an alarm application is provided. The alarm application displays currently open alarms, together with associated alarm attributes, transmitted by network elements of a telecommunications network. When the currently open alarms of the network elements are requested by the alarm application, only a predetermined set of alarm attributes relating to the respective alarm is requested and the current alarms with these alarm attributes are then transmitted by the respective network elements to the alarm application. Only after a specified alarm has been selected are the alarm attributes associated with the selected alarm, which alarm attributes have not yet been loaded, requested by the respective network element, reloaded and then displayed by the alarm application.

### CROSS REFERENCE TO RELATED APPLICATIONS

This application claims priority of European application No. 05112400.6 EP filed Dec. 19, 2005, which is incorporated by reference herein in its entirety.

### FIELD OF INVENTION

The invention relates to a method for loading a list of alarms by means of an alarm application.

### BACKGROUND OF INVENTION

A telecommunications network is understood by definition to be a generic term for all the resources through which network access points (e.g. terminal equipment) which are remote from one another can be connected to one another and by which services with service features for the exchange of information and for the transmission of data are made available.

A telecommunications network typically comprises a plurality of different network elements such as, for example, gateways, exchanges in line-bound telephone networks, switches, routers, bridges, hubs, etc. for computer networks or base stations, mobile switching centers, etc. in cellular networks. These network elements are connected to one another by means of a (physical) connection. The network access points can be connected either in a line-bound manner, as for example in fixed networks or computer networks, or linelessly, as for example in cellular networks or wireless LANs.

For administration, operation and maintenance in telecommunications networks—particularly in large telephone networks or computer networks—a network management system is used, through which network elements and services of the telecommunications network are managed. Network management systems usually comprise a plurality of subsystems by which the functions of the network management system are executed, such as, for example, configuration management, by means of which the planning, extension or modification of the layout of the telecommunications network or of the properties of its network elements is undertaken, security management, the aim of which is to help to prevent damage resulting from unauthorized intrusion into the telecommunications network (e.g. manipulation of data, unnoticed reconfiguration, etc.), or fault management.

Fault management covers all the activities which are used for fault detection and fault clearance in telecommunications networks. Fault management therefore comprises a set of functions for identifying, isolating and clearing malfunctions in telecommunications networks. A sub-area of fault management which is used in particular in the detection of malfunctions in telecommunications networks is the management of alarms or alarm management.

Alarms are dispatched by network elements in order to indicate a malfunction of the network element, such as, for example, permanent or temporary failure of a component of the network element, failure of a process running on the network element, a process running on the network element cannot be started, etc. The alarms occurring in a telecommunications network can be described in greater detail by means of alarm attributes such as, for example, alarm type, fault type, severity, time of the event triggering the alarm (event time), processing status, clearance type, alarm ID, etc. For example, a format for alarms and associated alarm attributes is defined by ITU-T recommendation X.733.

Alarms, together with the associated alarm attributes, are then managed with the aid of an alarm application. This alarm application usually provides functions which enable the monitoring and polling of network elements with regard to alarms and the associated alarm attributes. The alarm application also displays the alarms of network elements of the telecommunications network together with their alarm attributes e.g. in the form of a list and/or individually.

For the display of the alarms by the alarm application, these alarms, together with the associated alarm attributes, are either sent spontaneously by the respective network elements to the alarm application or requested from the network elements through a re-alignment of the alarm application.

Re-alignment customarily designates a deliberately initiated synchronization of the alarm application, whereby the respective currently open alarms, i.e. those not yet recorded and dealt with by fault-management functions, together with their alarm attributes are requested from the network elements of the telecommunications network. A re-alignment, or the requesting of currently open alarms of all the network elements, is carried out, for example, when the alarm application is restarted or following a link-lost situation. A link-lost situation designates a situation in the telecommunications network where e.g. the connection between one or more network elements of the telecommunications network and the alarm application has been interrupted.

After the alarm application is restarted or after a link-lost situation, the current alarm status—i.e. all currently open alarms with associated alarm attributes—of the network elements in the telecommunications network should if possible be available for the alarm application and be able to be displayed, so that the handling of critical faults in network elements is carried out rapidly. A re-alignment procedure, in which the current alarms are requested from all the network elements monitored by the alarm application, is therefore customarily carried out immediately or after a very short waiting period.

Customarily, an alarm application often monitors a plurality of network elements. Moreover, a large number of open alarms that have to be dealt with can occur in individual network elements. In a re-alignment procedure, it can therefore sometimes take a relatively long time until the alarms of the network elements and the associated alarm attributes are available for the alarm application and can be displayed by the alarm application. The re-alignment procedure may, for example, require a period of from several minutes to a few hours—as for example in the case of special network elements such as a radio commander of a cellular network. The consequence of this is that, for example, as a result of the long loading time there is a delay before special critical alarms can be displayed and therefore dealt with. Moreover, the transmission of many alarms and the transmission of the associated alarm attributes can lead to an additional loading on the telecommunications network.

Therefore, the number of alarms requested by the alarm application in re-alignment procedures is frequently restricted. Customary criteria for restriction are, for example, a restriction in the number of alarms (e.g. request for last 500 currently open alarms), a selection according to the time of occurrence of the alarms (e.g. display of only those alarms which are not more than 2 days old) or selection according to the severity of the alarms (e.g. display of only those alarms of “critical” severity), etc.

### SUMMARY OF INVENTION

This approach of restricting the number of alarms requested by the alarm application can, however, bring with it the disadvantage that important or critical alarms are not requested. These alarms are then not available for the alarm application and are therefore also not displayed. Moreover, technically complex handling processes for alarms transmitted spontaneously from network elements to the alarm application still have to be implemented when the alarms requested by the alarm application are restricted as a result of a re-alignment process.

An object of the present invention is to indicate a method by means of which the period of time from the request until the display of the alarms by the alarm application is shortened, all current alarms of the monitored network elements are made available to the alarm application and the loading on the telecommunications network as a result of the transmission of alarm data remains as low as possible.

The object is achieved in a method of the type mentioned in the introduction wherein, when the alarms are requested by the alarm application, a predetermined set of alarm attributes is requested for each alarm and the alarms, generated by the network elements, with these alarm attributes are then sent to the alarm application. Only after a defined alarm has been selected are the alarm attributes associated with this alarm which have not yet been loaded requested by the respective network element, reloaded and then displayed.

A key aspect of the solution proposed according to the invention consists in shortening the duration of time of the re-alignment process—i.e. of the requesting of the alarms from the monitored network elements by the alarm application—all pending network element alarms nonetheless being displayed. In addition, the loading on the telecommunications network resulting from the transmission of alarm data is kept advantageously low.

It is convenient if, after selection of a specified alarm, all the alarm attributes associated with this alarm are requested by the respective network element, reloaded and displayed, because by this means any changes in individual alarm attributes which may have occurred between the re-alignment process and the selection of the alarm are also displayed.

It is advantageous if the predetermined set of alarm attributes for each alarm can be adjusted depending on the network element, because in this way the information which is essential and of interest for the evaluation of the respective alarm or alarms of the respective network element can be displayed immediately by the alarm application in the re-alignment process e.g. in the clearance or handling of alarms. The alarm attributes which are of interest and are important are selected here before the re-alignment process, for example by selecting from all the available alarm attributes the alarm attributes required.

In a preferred further development of the invention, when the alarms are requested by the alarm application, the predetermined set of alarm attributes for each alarm is sent back by a network element and additional alarm attributes are requested from the respective network element only by means of an additional command. In this way, further alarm attributes which are important, for example for the clearance or treatment of alarms, can be requested in addition to the predetermined set of alarm attributes and can be displayed by the alarm application.

It is recommended that the Simple Network Management Protocol—SNMP—be used for the requesting of network element alarms by the alarm application because the Simple Network Management Protocol represents a defined protocol for reading and also for modifying management information such as e.g. alarms which are supplied by network elements.

In a preferred exemplary embodiment, the alarms are fashioned in accordance with the format defined in ITU-T recommendation X.733 with the alarm attributes defined in ITU-T recommendation X.733, as a result of which a standardized alarm format with defined alarm attributes can in an advantageous manner be accessed by the alarm application.

### BRIEF DESCRIPTION OF THE DRAWINGS

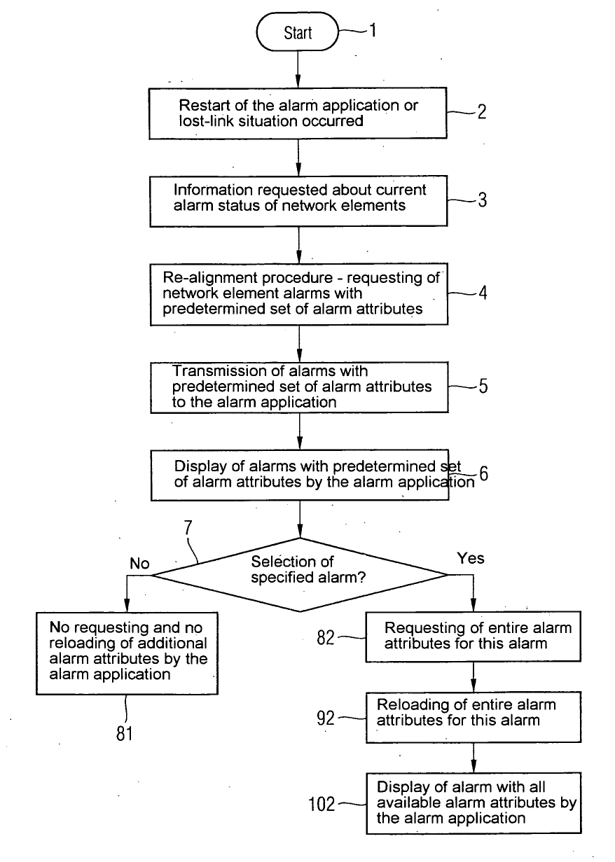

An exemplary embodiment of the invention will be explained in detail below with reference to the sole FIGURE. FIG. 1 shows the schematic flow of the inventive method for the loading of a list of alarms by an alarm application.

### DETAILED DESCRIPTION OF INVENTION

After a first start step 1, in a second step 2 an alarm application is restarted or it is established that a lost-link situation has occurred. This means that the connection between an alarm application and one or more network elements of a telecommunications network has been interrupted and consequently the alarms displayed in the alarm application may no longer correspond to the current alarm status.

Therefore, in a third step 3 it is detected that information about the current alarm status of the network elements of the telecommunications network is necessary, and in a fourth step 4 a re-alignment process is initiated by the alarm application. A deliberate synchronization of the alarm application is thus carried out, in which the alarm application requests currently open alarms of the network elements of the telecommunications network which it monitors. At the same time, a predetermined set of alarm attributes is also requested for each alarm, said set comprising only a few alarm attributes for each alarm.

The predetermined set of alarm attributes is defined before the re-alignment process, it being possible for this predetermined set to be, for example, a predefined standard set which is the same for all the alarms requested by the alarm application, or to be selected by a user specifically for a particular network element or even alarm. Here, the user can select, for example via check boxes in the alarm application, from all the alarm attributes those which are of most interest to him. It is also conceivable for the selection of the alarm attributes to be carried out automatically by the alarm application, the predetermined set then being determined depending on the alarm attributes which can be displayed in the alarm application.

In a fifth step 5, the alarms requested by the alarm application, together with the few alarm attributes of the network elements defined by means of the predetermined set, are then sent to the alarm application. In a sixth step 6, the alarms that are currently open and transmitted by the network elements, together with the few predefined alarm attributes, are then displayed by the alarm application e.g. in the form of a list.

If a user is then interested in further details relating to a specified alarm, then this alarm can then be selected, for example by selecting with the cursor in the list displayed in the alarm application, or a separate display for this alarm can be opened in the alarm application, e.g. by double-clicking on the alarm in the list. In a seventh step 7, a check is therefore made to ascertain whether a specified alarm has been selected.

If no specified alarm has been selected from the alarm list displayed in the alarm application, then in an eighth step 81, no further, as yet unloaded, alarm attributes relating to the alarms are requested or reloaded by the alarm application.

If, however, a specified alarm has been selected from the alarm list, then in a ninth step 82 the as yet unloaded alarm attributes which are associated with this alarm are requested from that network element by which the alarm has been issued. Alternatively, for example, all the alarm attributes associated with this alarm and available can also be rerequested from the corresponding network element in order that any new status of an alarm attribute from the predefined set also be recorded.

In a tenth step 92 the other as yet unloaded alarm attributes or all the available alarm attributes are then reloaded by the alarm application and in an eleventh step 102 the selected alarm, together with all available alarm attributes, is then displayed, e.g. in a separate display, by the alarm application.

1-6. (canceled)

7. A method for loading a list of alarms via an alarm application that displays alarms of network elements of a telecommunications network together with associated alarm attributes, comprising:
requesting a first subset of alarm attributes for each alarm when the alarms are requested by the alarm application;
receiving the alarms generated by the network elements with the first subset of alarm attributes by the alarm application;
selecting a specific alarm from the received alarms;
requesting a second subset of alarm attributes for the selected alarm;
receiving the second subset of alarm attributes; and
displaying the second set of alarm attributes in response to receiving the second subset of alarm attributes.

8. The method as claimed in claim 7, wherein the first and second subset of attributes are displayed in response to receiving the second subset of alarm attributes.

9. The method as claimed in claim 7, wherein the first subset of alarm attributes for each alarm is adjusted depending on the network element.

10. The method as claimed in claim 7, wherein the second subset of alarm attributes for each alarm can be adjusted depending on the network element.

11. The method as claimed in claim 7, wherein a Simple Network Management Protocol is used for the requesting of the network element alarms by the alarm application.

12. The method as claimed in claim 7, wherein the alarms are executed in accordance with a format defined in ITU-T recommendation X.733 with the alarm attributes defined in the ITU-T recommendation X.733.

13. The method as claimed in claim 1, wherein the second subset of attributes includes all alarm attributes associated with the selected alarm.

14. The method as claimed in claim 13, wherein the first subset of alarm attributes for each alarm can be adjusted depending on the network element.

15. The method as claimed in claim 14, wherein the second subset of alarm attributes are formed via an additional command.

16. The method as claimed in of claim 15, wherein a Simple Network Management Protocol is used for the requesting of the network element alarms by the alarm application.

17. The method as claimed in claim 16, wherein the alarms are executed in accordance with a format defined in ITU-T recommendation X.733 with the alarm attributes defined in the ITU-T recommendation X.733.

18. A method for loading a list of alarms via an alarm application that displays alarms of network elements of a telecommunications network together with associated alarm attributes, comprising:
requesting a first subset of alarm attributes for all current alarms of the network by the alarm application, the first subset of alarm attributes excludes at least one alarm attribute associated with the respective alarm;
receiving the alarms generated by the network elements with the first subset of alarm attributes by the alarm application;
selecting a specific alarm from the received alarms;
requesting all of the alarm attributes for the selected alarm from a network element associated with the alarm;
receiving all of the alarm attributes from the associated network element; and
displaying the all of the alarm attributes in response to receiving all of the alarm attributes from the associated network element.

19. The method as claimed in claim 18, wherein the first subset of alarm attributes for each alarm differs depending on the network element.

20. The method as claimed in claim 18, wherein a Simple Network Management Protocol is used for the requesting of the network element alarms by the alarm application.

21. The method as claimed in claim 18, wherein the alarms are executed in accordance with a format defined in ITU-T recommendation X.733 with the alarm attributes defined in the ITU-T recommendation X.733.

22. The method as claimed in claim 19, wherein the first subset of alarm attributes for each alarm differs depending on the network element.

23. The method as claimed in claim 22, wherein a Simple Network Management Protocol is used for the requesting of the network element alarms by the alarm application.
